(19) United States
(12) Patent Application Publication
(10) Pub. No.: US 2006/0034249 A1
(43) Pub. Date: Feb. 16, 2006

(54) Header compression between a compressor and a decompressor

(76) Inventors: Hans Kallio, Nokia (FI); Jani Haapakoski, Tampere (FI); Mika Uimonen, Tervakoski (FI)

Correspondence Address: PERMAN & GREEN, 425 POST ROAD, FAIRFIELD, CT, 06824, US

(21) Appl. No.: 11/184,552

(22) Filed: Jul. 19, 2005

(30) Foreign Application Priority Data
Jul. 20, 2004 (FI) 20041005

(51) Int. Cl. H04J 3/24

(52) U.S. Cl. 370/349

(57) ABSTRACT

The method relates to a method for header compression between a compressor and a decompressor. The method includes providing a set of configuration parameters to be negotiated between the compressor and the decompressor, wherein the set includes a specific parameter whose value indicates whether reordering and/or packet loss is tolerated between the compressor and the decompressor. The method further includes indicating in a full header whether subsequent compressed headers will contain small packet sequence numbers (pkt_nr). These small packet sequence numbers (pkt_nr) are used in order to detect a reordering of packets and/or packet loss between the compressor and the decompressor.

### FIELD OF THE INVENTION

The invention generally relates to header compression between a compressor and a decompressor.

### BACKGROUND OF THE INVENTION

In packet-based communication a packet sent from a transmitting device to a receiving device typically comprises control data in several header fields as well as the actual user data, i.e., payload. In a typical situation the content of many header fields either remains the same during the whole transmission session or it changes only by a predictable amount from packet to packet. This matter has been the starting point for several header compression techniques, in which, instead of sending every header field of each packet (i.e., a full header or an uncompressed header) from the transmitting device to the receiving device, only the changes are communicated in the form of a compressed header.

The Degermark header compression method has been specified in IETF RFC 2507 to compress UDP/IP and TCP/IP header fields. IP versions 4 and 6 are supported. The method has been widely spread. For example, several mobile protocols, such as 2^{nd} generation Release 99 of Subnetwork Dependent Convergence Protocol (SNDCP) and 3^{rd} generation release 99 and further releases of Packet Data Convergence Protocol (PDCP), make use of Degermark header compression.

As many header compression methods, Degermark header compression is based on transmitting changing header field information detected between packets. Transmission of redundant header field information is tried to be avoided. In Degermark header compression data streams are handled on a flow basis so that each entity creates a separate context for each TCP or UDP flow. For example, packets of a single TCP flow have their own context. As defined in RFC 2507, the term context means the state which the compressor uses to compress a header and the decompressor uses to decompress a header. Typically, in normal operation of the system, the context is the uncompressed version of the last header sent from the compressor or received at the decompressor.

The context is initialized by storing both static and dynamic header information in a compressor of the transmitting device and by sending the same information in a full header to a receiving device and by storing the received information in a decompressor of the receiving device. According to RFC 2507 the full header is otherwise identical to a normal packet header except that, when certain packet types are in use, a special IP length field therein is used to carry from the compressor to the decompressor a context identifier (CID) identifying the context in question. Optionally, a small sequence number is sent in the same field. After initialization the compressor starts to send compressed packets, which generally contain only the changing header information between packets of the flow. Depending on the configuration of the established session between the compressor and the decompressor, the type of compressed packets in use may vary. For example, the type of COMPRESSED_TCP or COMPRESSED_TCP_NODELTA may be used as far as TCP protocol is concerned.

Before proper Degermark compression in accordance with RFC 2507 can be carried out, a suitable set of configuration parameters is negotiated between the compressor and the decompressor during the initialization phase of the session. Here the term session means the session which is provided by a transmission channel which the compressor and decompressor use. This session comprises, with their life cycles, all the specific flows which the user applications have opened during the session. Standard specifications define which parameters belong to the set of negotiable parameters and which not. As to the parameters, which are not to be negotiated, the DEFAULT values, as defined in RFC 2507, are used. One specific example of a parameter negotiation procedure is presented in the standard specification 3GPP TS 04.65 V8.2.0 which presents a SNDCP parameter negotiation procedure called SNDCP XIP negotiation.

A configuration parameter called EXPECT_REORDERING is defined in RFC 2507. This parameter indicates whether successful compression and decompression tolerates reordering (i.e., packets received in wrong order) and/or loss of packets. The parameter can take values TRUE or FALSE.

In the following, a TCP packet flow is especially concerned. The value FALSE of EXPECT_REORDERING defines that packet reordering or loss is not allowed if successful decompression is to be guaranteed. The packet type to be used for sending compressed headers is COMPRESSED_TCP defined in RFC 2507. Compression and decompression of this type of packets is based on changes between header fields of consecutive packets. Successful decompression of a packet is based on successful decompression of a previous packet. Thus, packet loss or reordering is not tolerated. If a packet loss or reordering occurs, the context (at least for decompression) will be damaged and also subsequent packet loss will follow. It has been proposed that this problem could be prevented by sending appropriate signaling from one end to the other end, but even so it is probable that significant drop of throughput is experienced.

The value TRUE of parameter EXPECT_REORDERING defines that packet reordering or loss is allowed (at least to some extent). Mechanisms, which tolerate packet loss and reordering, are used. The packet type to be used for sending compressed headers is again COMPRESSED_TCP but now a small packet sequence number (pkt_nr) added into it. This requires maintenance of a sliding window mechanism in the decompressor. If the sliding window is desired not to be used, it is suggested to send compressed packets using another packet type, namely COMPRESSED_TCP_NODELTA (also defined in RFC 2507). These packets are much larger than COMPRESSED_TCP. However, their use removes the dependency of compressed packets. Hence, successful decompression does not require successful decompression of the previous packet anymore.

According to 3GPP TS 04.65 V8.2.0 the parameter EXPECT_REORDERING does not belong to the set of negotiable parameters in the SNDCP XIP negotiation. Accordingly, EXPECT_REORDERING always has the initial value of FALSE as defined in RFC 2507.

### SUMMARY OF THE INVENTION

Now it has been observed that it gives a disadvantage if the value of EXPECT_REORDERING is always FALSE. This can be seen, for example, in a case in which a lower layer protocol provides for the use of acknowledgement and unacknowledgement modes. In the acknowledgement mode, the protocol takes care that the reception of transmitted packets is guaranteed for example via the use of acknowledgements and/or retransmissions. In the unacknowledgement mode, on the other hand, the probability of packet loss or reordering increases since, typically, no retransmissions are possible.

For example, when the TCP packets and SNDCP protocol are concerned, usually the applicable lower level protocol, e.g., LLC (Logical Link Control), provides the possibility to use either the acknowledgement or unacknowledgement mode. If the unacknowledgement mode of LLC is used, the probability of packet loss and reordering increases. If the value of EXPECT_REORDERING is FALSE, as suggested by the current standard specifications, packet losses and reordering on a lower level (such as LLC) cause a significant drop in the throughput of the system using Degermark header compression. Namely, if lower level retransmissions (such as LLC retransmissions) are not possible (which is the case with unacknowledgement mode) and the mechanisms (e.g., using packet type COMPRESSED_TCP_NODELTA) already mentioned previously in the description are disabled (because EXPECT_REORDERING is FALSE) packet losses or reordering will finally have to be discovered and recovered in a more complicated recovery procedure on a higher level, such as on TCP level.

Accordingly, it has been observed that it would be desirable to have the possibility to set the parameter defining whether reordering and/or packet is tolerated as far as successful compression and decompression is concerned, such as EXPECT_REORDERING, to the value TRUE in the initialization phase. However, if the lower level protocol, such as LLC, uses the acknowledgement mode, it would, in some cases, be more appropriate that the parameter is set to value FALSE, if the recovery from packet losses is taken care of by the lower layer protocol.

According to a first aspect of the invention there is provided a method for header compression between a compressor and a decompressor, the method comprising: providing a set of configuration parameters to be negotiated between the compressor and the decompressor, wherein said set comprises a specific parameter whose value indicates whether reordering and/or packet loss is tolerated between the compressor and the decompressor.

Accordingly, embodiments of the invention provide for putting the parameter EXPECT_REORDERING among the configuration parameters to be negotiated in SNDCP XID negotiation. If loosing and/or reordering of packets is possible on lower link, i.e., on LLC, the value of the parameter EXPECT_REORDERING can be negotiated to TRUE. This is in contrast to previous proposals in which the value of EXPECT_REORDERING is always FALSE irrespective of whether the lower link used acknowledgement or unacknowledgement mode, whereas in embodiments of the invention the parameter value can be negotiated and the fact whether acknowledgement or unacknowledgement mode is used can be taken into account in the negotiation.

However, other embodiments of the invention provide that irrespective of which mode is used on the lower level, the value of EXPECT_REORDERING may still be desirable to be set to TRUE.

In an embodiment of the invention, it is further indicated in a full header whether a subsequent compressed header will contain a small packet sequence number. In an embodiment, these small packet sequence numbers are used in order to detect a reordering of packets and/or packet loss between the compressor and the decompressor.

According to further aspects of the invention, there is provided a transmitting device as defined is claim 14, a receiving device as defined is claim 22, a system as defined is claim 30, a software application executable in a transmitting device as defined is claim 31 and a software application executable in a receiving device as defined is claim 32.

The software applications may be computer program products, comprising program code, stored on a medium, such as a memory.

Dependent claims relate to embodiments of the invention. The subject matter contained in dependent claims relating to a particular aspect of the invention is also applicable to other aspects of the invention.

### BRIEF DESCRIPTION OF THE DRAWINGS

Embodiments of the invention will now be described by way of example with reference to the accompanying drawings in which:

FIG. 1 shows a general framework in accordance with embodiments of the invention;

FIG. 2 shows a protocol architecture in accordance with an embodiment of the invention;

FIG. 3 shows a parameter negotiation procedure in accordance with an embodiment of the invention;

FIG. 4 illustrates the use of a sequence number in accordance with an embodiment of the invention;

FIG. 5 shows a packet type for a compressed header in accordance with an embodiment of the invention;

FIG. 6 presents a block diagram showing details of a transmitting device in accordance with an embodiment of the invention;

FIG. 7 presents a block diagram showing details of a receiving device in accordance with an embodiment of the invention; and

FIG. 8 illustrates the general format of packets which are sent between compressing and decompressing entities in accordance with an embodiment of the invention.

### DETAILED DESCRIPTION

The subject matter contained in the introductory portion of this patent application can be used to support the detailed description.

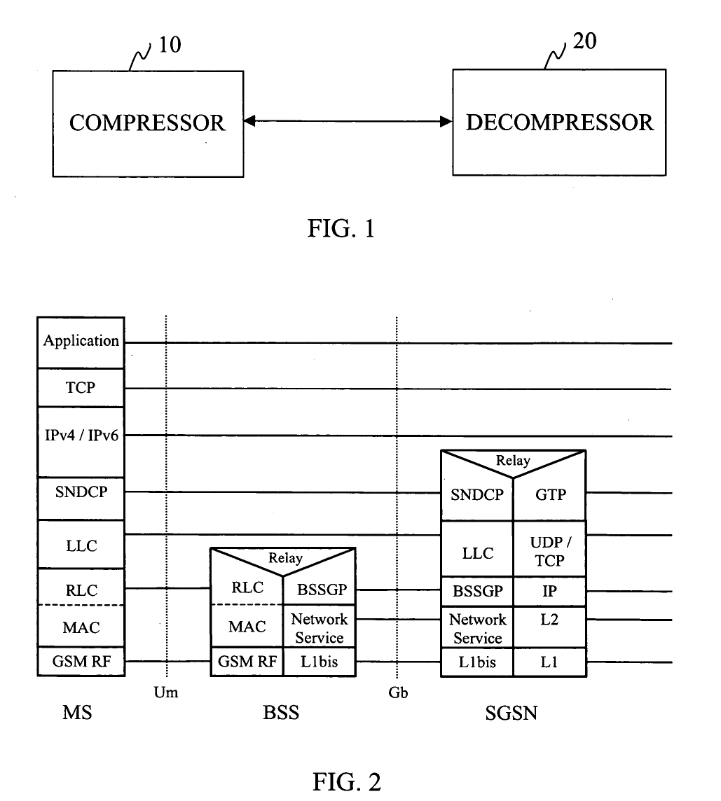

FIG. 1 shows a general framework in accordance with embodiments of the invention. The compressor 10 of a transmitting device sends compressed headers to the decompressor 20 of a receiving device. The transmitting device may be, e.g., a mobile communication device of a cellular network. The receiving device may be e.g. a network element of a cellular network, such as a SGSN. The compressor 10 compresses the headers and the decompressor 20 decompresses the compressed headers in accordance with Degermark header compression method as described in RFC 2507. The contents of document RFC 2507 are fully incorporated in the present patent application by reference.

FIG. 2 shows a protocol architecture in accordance with an embodiment of the invention. The mobile communication device MS has a protocol stack comprising an application layer, a TCP layer, an IP layer, a SNDCP layer, a LLC layer, a RLC/MAC layer and a GSM RF layer. The application layer, TCP layer and IP layer communicate with corresponding layers of a peer not shown in FIG. 2, but which may be another mobile communications device or a network element. The SNDCP layer and LLC layer communicate with corresponding layers of the SGSN. Communication with a base station subsystem BSS over an Um interface is handled with the aid of the RLC/MAC layer and GSM RF layer.

The base station subsystem BSS comprises a relay entity, an RLC/MAC layer and a GSM RF layer which communicate with corresponding layers of the mobile communication device MS. Furthermore the base station subsystem BSS comprises a BSSGP layer, a Network Service layer and a L1Bis layer for communication over a Gb interface towards the SGSN. The SGSN comprises a relay entity, a BSSGP layer, a Network Service layer and a L1Bis layer which communicate with corresponding layers of the base station subsystem BSS. Above the BSSGP layer, the SGSN comprises a SNDCP layer and a LLC layer which communicate with the corresponding layers of the mobile communication device MS. The SGSN further comprises other layers (e.g., GTP, UDP/TCP, IP, L2 and L1 shown in FIG. 2) for communication towards another network element, such as a GGSN (Gateway GPRS Support Node).

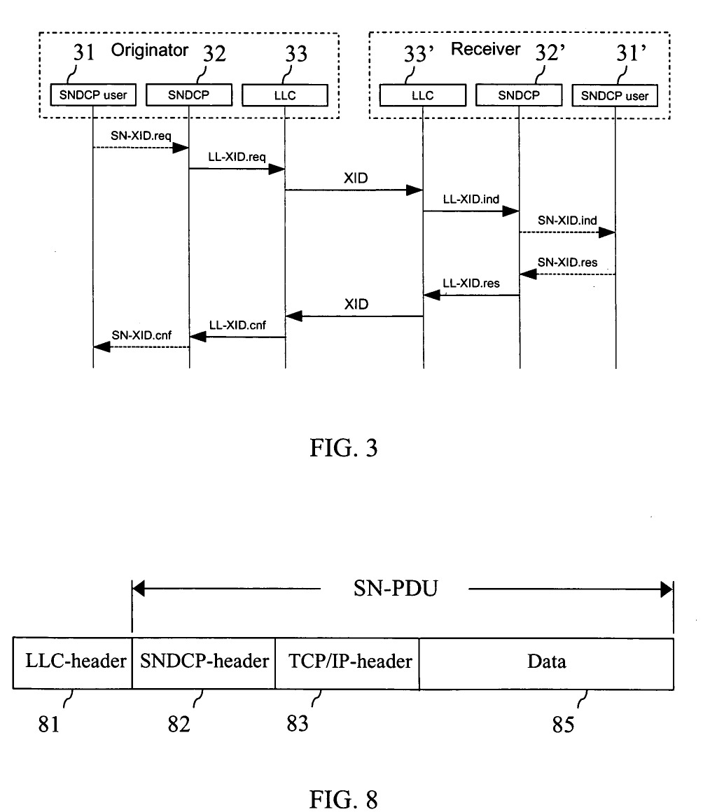

FIG. 3 shows a parameter negotiation procedure in accordance with an embodiment of the invention. The negotiation procedure generally corresponds to the negotiation of SNDCP exchange identity (XID) parameters between peer SNDCP entities presented in document 3GPP TS 04.65 V8.2.0, the contents of the document being fully incorporated in the present patent application by reference. However, the difference between the negotiation presented in 3GPP TS 04.65 V8.2.0 and the negotiation in accordance with the present embodiment is that, contrary to what has been presented in 3GPP TS 04.65 V8.2.0, the parameter indicating whether reordering and/or packet loss is expected (or tolerated), i.e., EXPECT_REORDERING belongs to the set of negotiable parameters in the present embodiment.

The purpose of the XID parameter negotiation is to ensure optimal information transfer by configuring the transmission channel between the compressor and the decompressor in the most appropriate way. The negotiation may be initiated by the SNDCP entity or the SNDCP user at the mobile communication device MS or at the SGSN.

As specified in 3GPP TS 04.65 V8.2.0 the task of the SNDCP entity is to handle the service functions provided by the SNDCP layer. The SNDCP user, instead of that, is a protocol entity that is using the services provided by the SNDCP layer. For example PDP entities and control entities are SNDCP users at the MS. The relay entity is the SNDCP user at the SGSN.

As described in 3GPP TS 04.65 V8.2.0, the XID negotiation is a one-step procedure, i.e., the initiating end proposes parameter values, and the responding end (in FIG. 3 referred to as the receiver) either accepts these or offers different values in their place. The SNDCP user 31 of the originator uses SN-XID.request to initiate the negotiation of the XID parameters. The SNDCP entity 32 (the compressing entity) of the originator sends the proposed SNDCP XID parameters to the LLC SAP 33 (Service Access Point) of the originator with the LL-XID.request. The LLC SAP 33 of the originator generates an XID command containing the SNDCP XID parameters. The LLC SAP 33′ of the receiver (peer LLC SAP) indicates, upon receipt of the XID command, the SNDCP XID parameters to SNDCP entity 32′ (the decompressing entity) of the receiver using LL-XID.indication. The SNDCP entity 32′ of the receiver (peer SNDCP) selects appropriate values for the proposed parameters or negotiates the appropriate values with the SNDCP user 31′ of the receiver with the SN-XID.indication and SN-XID.response primitives. When the appropriate parameter values are known by the SNDCP entity 32′ of the receiver, it uses the LL-XID.response primitive to continue negotiation. The LLC SAP 33′ generates an XID response containing the SNDCP XID parameters, which XID response is sent to the originator. Upon reception of the XID response, the LLC SAP 33 of the originator sends the received parameters to the SNDCP entity 32 of the originator using the LL-XID.confirm primitive. The SNDCP entity 32 delivers the negotiated parameters to the SNDCP user 31.

Now that the parameter EXPECT_REORDERING belongs to the set of negotiable parameters, the SNDCP can take the mode of the lower layer into account when negotiating configuration parameters. For example, SNDCP that is operating with reliability class 3 (i.e., RC3) may now take advantage of LLC layer's unacknowledgement mode. According to an embodiment of the invention, the value of parameter EXPECT_REORDERING is negotiated to TRUE if the LLC is using unacknowledgement mode and to FALSE if the LLC is using acknowledgement mode. However, the invention is not limited to this embodiment. Generally, it is of more importance, that the parameter value now can be negotiated based on different factors.

Some other embodiments of the invention concentrate on the fact that regardless of a successful negotiation of configuration parameters in the initiation phase it is possible that incompatibility is reach between the compressor and the decompressor, if certain compressed packet types are used. Especially, if the parameter value of EXPECT_REORDERING is negotiated to TRUE, this causes an additional problem when Degermark header compression is used. Namely, if EXPECT_REORDERING=TRUE, the compressor may in accordance with RFC 2507 send compressed headers using the packet type COMPRESSED_TCP either with a small packet sequence number (pkt_nr) or without it. Prior-art methods do not provide for detecting which of the mentioned two cases is in question. In the following description, this problem is discussed in more detail.

RFC 2507 states that if EXPECT_REORDERING=TRUE the mechanisms which tolerate reordering are used. These mechanisms comprise sending headers by using the packet type COMPRESSED_TCP_NODELTA or the packet type COMPRESSED_TCP. As mentioned in the foregoing, if the packet type COMPRESSED_TCP is used, the compressed header may be sent with a small packet sequence number (pkt_nr) or without it. RFC 2507 defines more closely that the sequence number is two octets long and that it is incremented by one for every packet in the TCP stream. It is associated with each full header and each compressed header. This allows the decompressor to place the packets in the correct sequence. The packets are placed in the correct order by a sliding window scheme.

As described in RFC 2507, full TCP/IP header(s) sent during initialization will only have space for one octet of sequence number when there is no tunneling. Therefore only the least significant octet of the packet sequence number, i.e. eight bits in total, can be placed in such full headers. In the tunneling case the full two octet sequence number can be transmitted.

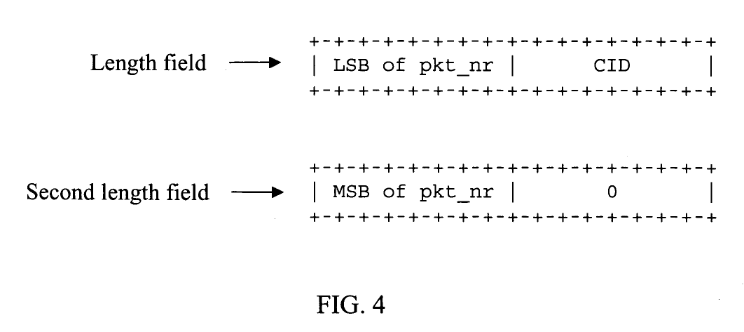

FIG. 4 illustrates the use of a sequence number in connection with full headers in accordance with RFC 2507. The full header is otherwise similar to a normal TCP/IP packet header but the length field of IP header therein is replaced with the context identifier CID and an octet of least significant bits (LSB) of the sequence number. If a second length field is available (e.g., tunneling case), the octet of most significant bits MSB is placed in there, the remaining portion of the second length field being zero.

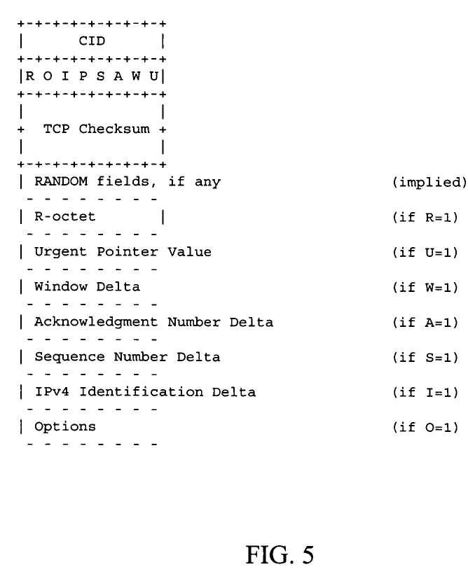

FIG. 5 shows a compressed packet of the packet type COMPRESSED_TCP in accordance with RFC 2507. The place of the two octets long packet sequence number is right after the TCP checksum field. The rest of the fields visible in FIG. 5 are known as such for a skilled person.

Returning back to the problem concerning detection whether the packet sequence number is present in the packet of the packet type COMPRESSED_TCP in the situation where EXPECT_REORDERING=TRUE, an embodiment of the invention presents a solution as follows.

Firstly, it is assumed that the packet sequence number is included either to every packet or none of the packets in a certain context. In accordance with this embodiment, the packet sequence number field of the full header, typically sent in the initialization phase, is used to indicate whether the following compressed packets contain a sequence number. If the packet sequence number field of the full header (situated in the length field of the TCP/IP packet) has a value of non-zero, all subsequent COMPRESSED_TCP packets of the same context have packet sequence numbers as well. If the packet sequence number field of the full header has a value of zero, all subsequent COMPRESSED_TCP packets of the same context have not a packet sequence number. Here, it should be noted that RFC 2507 forbids the packet sequence number zero to be used because of a TCP window scale option related problem. However, the present embodiment does not contradict RFC 2507 since the number zero is not used, as such, as a sequence number in the full header but as an indication only, indicating that subsequent packets do not contain sequence numbers.

Detection of the presence of packet sequence numbers is done at the decompressor in following manner:

The value of the packet sequence number is checked from the full header of the context at the decompressor:
if packet sequence number is zero, the decompressor deduces that the following COMPRESSED_TCP packets do not have packet sequence numbers;
if packet sequence number is non-zero, the decompressor deduces that the following COMPRESSED_TCP packets have packet sequence numbers.

In an alternative embodiment, the problem concerning the packet sequence numbers and the situation in which EXPECT_REORDERING is TRUE is avoided by defining that if EXPECT_REORDERING is TRUE, all COMPRESSED_TCP packets have always to contain the packet sequence number.

Embodiments of the invention make it possible to configure the SNDCP layer in a more optimal manner to prevent additional packet loss by negotiating the value of parameter EXPECT_REORDERING by taking the mode of the LLC layer into account in 2^{nd} and 2.5^{th} generation mobile communication systems. Also the ambiguous interpreting of compressed packets (such as COMPRESSED_TCP) when the parameter EXPECT_REORDERING=TRUE can be handled without confusion wherever the header compression defined in RFC 2507 is used, e.g., in SNDCP of the 2^{nd} or 2.5^{th} generation mobile communication systems or PDCP of the ₃rd or further generation mobile communication systems.

Another embodiment of the invention concerns the situation in which the parameter EXPECT_REORDERING has been negotiated FALSE but the incoming packet arriving at the decompressor still has the small packet sequence number (pkt_nr). In most cases, this would present an error situation, since said sequence numbers should not be used in the case where EXPECT_REORDERING is FALSE. In order to solve this problematic situation, the decompressor is, in accordance with the present embodiment, configured to carry out the following interpretation:
if EXPECT_REORDERING=FALSE and if pkt_nr is non-zero, said packet number is simply ignored.

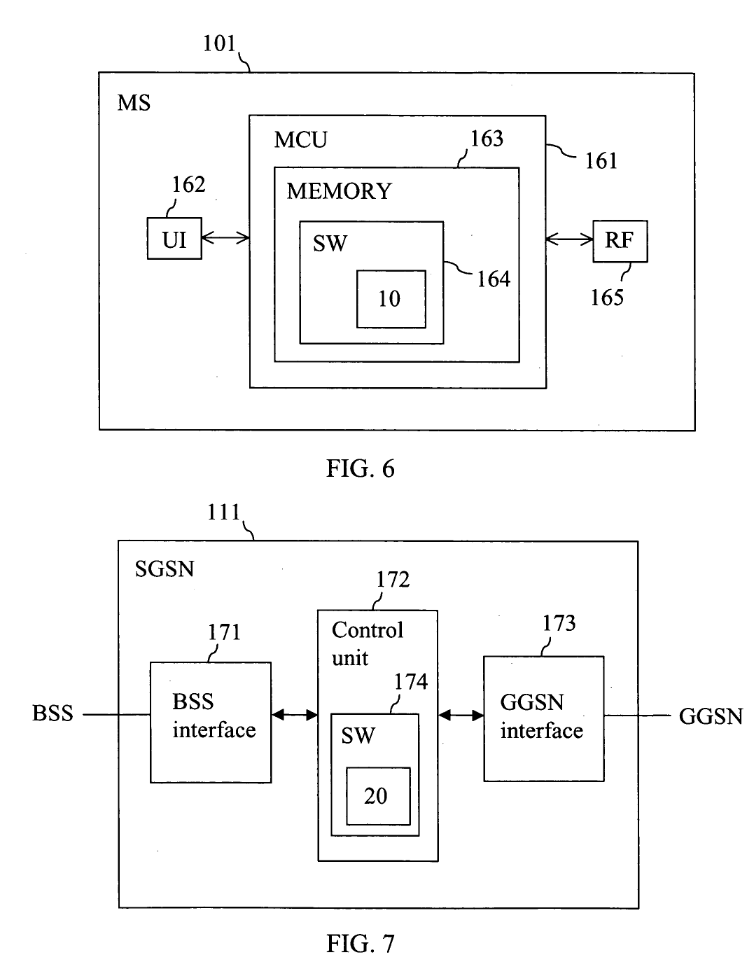

FIG. 6 presents a block diagram showing details of a transmitting device 101 and FIG. 7 presents a block diagram showing details of a receiving device 111 in accordance with an embodiment of the invention. The transmitting device 101 may be, for example, a mobile communications device of a cellular network and the receiving device 111 a network element or entity such as the SGSN. Alternatively, the transmitting device 101 may operate as a receiving device and the receiving device 111 as a transmitting device.

The transmitting device 101 (FIG. 6) comprises a processing unit 161, a radio frequency part 165 and a user interface 162. The radio frequency part 165 and the user interface 162 are coupled to the processing unit 161. The user interface 162 typically comprises a display, a speaker and a keyboard (not shown) with the aid of which the user can use the device 101.

The processing unit 161 comprises a processor (not shown), a memory 163 and computer software 164 stored in the memory 163. The software 164 comprises program code for implementing appropriate protocol layers and a compressing entity, i.e., the compressor 10. For example, the SNDCP and LLC layers as well as upper layers are implemented be software. Lower layers may be implemented by a suitable combination of software and hardware.

The processor controls, in accordance with the software 164, the operation of the transmitting device 101, such as the operation of the user interface 162 and the header compression operation of the compressor 10. The messages (or packets) relating to configuration parameter negotiation and packets of the actual data transmission are generated by the processing unit 161 and sent by the radio frequence part to the receiving device 111. Transmission typically occurs via an intermediate element, such as the base station subsystem.

The receiving device 111 (FIG. 7) comprises a control unit 172, a BSS interface 171 and a GGSN interface 173. The BSS interface 171 and the GGSN interface 173 are coupled to the control unit 172.

The control unit 172 comprises a memory (not shown) and computer software 174 stored in the memory. The software 174 comprises program code for implementing appropriate protocol layers and a decompressing entity, i.e., the decompressor 20. The control unit 172 controls, in accordance with the software 174, the operation of the header decompression operation of the decompressor 20.

The messages (or packets) relating to configuration parameter negotiation and relating to the actual data transmission are handled by the control unit 172. Communication with the transmitting device 101 is effected via the interface which is here denoted as the BSS interface 171 and communication towards the GGSN and (possibly) other networks is effected via the via the interface which is here denoted as the GGSN interface 173.

FIG. 8 illustrates the general format of the packets which are sent between the compressing and decompressing entities (here: SNDCP entities) during data transmission. As defined in 3GPP TS 04.65 V8.2.0 the data is sent in packet data units (SN-PDU). An SN-PDU comprises headers 82-83 and payload 85. The SN-PDU shown in FIG. 8 has a SNCDP-header 82 comprising SNDCP header fields, a TCP/IP-header 83 comprising TCP and IP header fields. It may also have upper layer headers (not shown). The payload field 85 carries the actual user data.

SN-PDUs are transferred from the transmitting device to the receiving device via the LLC layer (the layer residing just below the SNDCP layer). Therefore, FIG. 8 also shows a header added by the LLC-layer, i.e., the LLC-header 81 (visible in front of the SN-PDU). Service primitives as defined in 3GPP TS 04.65 V8.2.0 are used for communication between SNDCP and LLC layers.

As defined in 3GPP TS 04.65 V8.2.0 two different SN-PDU formats are defined for data transmission. The format SN-DATA PDU is used when LLC acknowledgement mode is used, whereas the format SN-UNITDATA PDU is used when LLC unacknowledgement mode is used for data transmission. When the parameter EXPECT_REORDERING has been negotiated TRUE and if the small packet sequence number (pkt_nr) is used, it is contained in the length field of the compressed form of the TCP/IP-header 83 (TCP or IP header) as described in the foregoing.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method for header compression between a compressor and a decompressor, the method comprising:
providing a set of configuration parameters to be negotiated between the compressor and the decompressor, wherein said set comprises a specific parameter whose value indicates whether reordering and/or packet loss is tolerated between the compressor and the decompressor.

2. The method according to claim 1, wherein the method comprises:
indicating in a full header whether a subsequent compressed header will contain a packet sequence number.

3. The method according to claim 2, wherein the method comprises:
indicating in the full header whether the subsequent compressed header will contain the packet sequence number in a situation in which said specific parameter has been negotiated to the value which indicates that reordering and/or packet loss is tolerated.

4. The method according to claim 2, wherein the full header comprises a specific header field whose specific first value indicates that the subsequent compressed header will not contain the packet sequence number and whose value other than the first value indicates that the subsequent compressed header will contain the packet sequence number.

5. The method according to claim 4, wherein said specific first value is the value zero and said value other than the first value is a non-zero value.

6. The method according to claim 5, wherein said non-zero value is the first packet sequence number or comprises bits of the first packet sequence number, such as a number of least significant bits of the first packet sequence number.

7. The method according to claim 2, wherein the full header is sent from the compressor to the decompressor during an initialization phase of a session.

8. The method according to claim 2, wherein said specific field used for indicating whether a subsequent compressed header will contain a packet sequence number is a length field, such as an IP length field.

9. The method according to claim 2, wherein the compressed header comprises a compressed TCP header, such as a header of the type COMPRESSED_TCP.

10. The method according to claim 1, wherein the method comprises:
taking the mode of a lower protocol layer, such as LLC (Logical Link Control) acknowledgement/unacknowledgement mode, into account when negotiating the value of the specific parameter whose value indicates whether reordering and/or packet loss is tolerated.

11. The method according to claim 1, wherein the specific parameter whose value indicates whether reordering and/or packet loss is tolerated is the parameter EXPECT_REORDERING.

12. The method according to claim 1, wherein the compressor and the decompressor are SNDCP (Subnetwork Dependent Convergence Protocol) entities.

13. The method according to claim 1, wherein the negotiation is the SNDCP XID negotiation.

14. A transmitting device comprising a compressor for header compression between the compressor and a decompressor, said transmitting device comprising:
means for providing a set of configuration parameters to be negotiated between the compressor and the decompressor, wherein said set comprises a parameter whose value indicates whether reordering and/or packet loss is tolerated between the compressor and the decompressor.

15. The transmitting device according to claim 14, wherein the transmitting device comprises:
means for indicating in a full header whether a subsequent compressed header will contain a packet sequence number.

16. The transmitting device according to claim 15, wherein the full header comprises a specific header field whose specific first value indicates that the subsequent compressed header will not contain the packet sequence number and whose value other than the first value indicates that the subsequent compressed header will contain the packet sequence number.

17. The transmitting device according to claim 16, wherein said specific first value is the value zero and said value other than the first value is a non-zero value.

18. The transmitting device according to claim 17, wherein said non-zero value is the first packet sequence number or comprises bits of the first packet sequence number, such as a number of least significant bits of the first packet sequence number.

19. The transmitting device according to claim 15, wherein said specific field used for indicating whether a subsequent compressed header will contain a packet sequence number is a length field, such as an IP length field.

20. The transmitting device according to claim 14, wherein the transmitting device comprises:
means for taking the mode of a lower protocol layer, such as LLC (Logical Link Control) acknowledgement/unacknowledgement mode, into account when negotiating the value of the specific parameter whose value indicates whether reordering and/or packet loss is tolerated.

21. The transmitting device according to claim 14, wherein the transmitting device is selected from the group comprising: a terminal device of a communications network, such as a wireless terminal device of a mobile communications network, and a network element of a communications system, such as a support node of a mobile communications system.

22. A receiving device comprising a decompressor for decompression of compressed headers received from a compressor, said receiving device comprising:
means for negotiating a set of configuration parameters between the decompressor and the compressor, wherein said set comprises a parameter whose value indicates whether reordering and/or packet loss is tolerated between the compressor and the decompressor.

23. The receiving device according to claim 22, wherein the receiving device comprises:
means for receiving an indication in a full header whether a subsequent compressed header will contain a packet sequence number.

24. The receiving device according to claim 23, wherein the full header comprises a specific header field whose specific first value indicates that the subsequent compressed header will not contain the packet sequence number and whose value other than the first value indicates that the subsequent compressed header will contain the packet sequence number.

25. The receiving device according to claim 24, wherein said specific first value is the value zero and said value other than the first value is a non-zero value.

26. The receiving device according to claim 25, wherein said non-zero value is the first packet sequence number or comprises bits of the first packet sequence number, such as a number of least significant bits of the first packet sequence number.

27. The receiving device according to claim 23, wherein said specific field used for indicating whether a subsequent compressed header will contain a packet sequence number is a length field, such as an IP length field.

28. The receiving device according to claim 22, wherein the receiving device comprises:
means for taking the mode of a lower protocol layer, such as LLC (Logical Link Control) acknowledgement/unacknowledgement mode, into account when negotiating the value of the specific parameter whose value indicates whether reordering and/or packet loss is tolerated.

29. The receiving device according to claim 22, wherein the receiving device is selected from the group comprising: a terminal device of a communications network, such as a wireless terminal device of a mobile communications network, and a network element of a communications system, such as a support node of a mobile communications system.

30. A system comprising a compressor and a decompressor for header compression between the compressor and the decompressor, the system comprising:
means for providing a set of configuration parameters to be negotiated between the compressor and the decompressor, wherein said set comprises a parameter whose value indicates whether reordering and/or packet loss is tolerated between the compressor and the decompressor.

31. A software application executable in a transmitting device, the software application comprising:
program code for implementing a compressor for header compression between the compressor and a decompressor; and
program code for providing a set of configuration parameters to be negotiated between the compressor and the decompressor, wherein said set comprises a parameter whose value indicates whether reordering and/or packet loss is tolerated between the compressor and the decompressor.

32. A software application executable in a receiving device, the software application comprising:
program code for implementing a decompressor for decompression of compressed headers received from a compressor; and
program code for negotiating a set of configuration parameters between the decompressor and the compressor, wherein said set comprises a parameter whose value indicates whether reordering and/or packet loss is tolerated between the compressor and the decompressor.
